(19) United States
(12) Patent Application Publication
(10) Pub. No.: US 2022/0374891 A1
(43) Pub. Date: Nov. 24, 2022

(54) TRANSACTION DATA PROCESSING

(71) Applicant: International Business Machines Corporation, Armonk, NY (US)

(72) Inventors: Shi Lei Zhang, Beijing (CN); Li Zhang, Beijing (CN); Toyotaro Suzumura, Tokyo (JP); Ryo Kawahara, Tokyo (JP)

(21) Appl. No.: 17/302,941

(22) Filed: May 17, 2021

(51) Int. Cl. G06Q 20/40; G06Q 40/02; G06N 3/04; G06N 7/00

(52) U.S. Cl. CPC G06Q 20/401; G06Q 40/02; G06N 3/049; G06N 7/005

(57) ABSTRACT

A dynamic graph embedding method for transaction data analysis includes obtaining transaction data associated with an account during a plurality of time windows, extracting spatial-temporal information of the transaction data by using a graph convolutional network and a transformer framework, and generating a feature representation for the account based on the spatial-temporal information.

### BACKGROUND

The present disclosure relates to machine learning, and more specifically, to a method, system, and computer program product for transaction data processing.

Financial transactions between merchants, customers, lenders and banks present a rich view of economic activities within a market. This type of data is usually represented as a heterogeneous graph of market participants, in which multiple nodes representing multiple accounts are connected by edges representing transactions. This is a particularly useful formulation for tackling critical business problems like credit risk modeling, fraud detection, money laundering detection and the like. However, such a graph is usually very high dimensional and very sparse, thus limiting the utility of the graph for financial data analysis tasks.

### SUMMARY

In one aspect of the present invention, a method, a computer program product, and a system includes: obtaining transaction data associated with an account during a plurality of time windows; extracting spatial-temporal information of the transaction data by using a graph convolutional network and a transformer framework; and generating a feature representation for the account based on the spatial-temporal information.

According to an additional aspect of the present invention the transaction data is represented as a plurality of graphs corresponding to the plurality of time windows. Each graph comprises a plurality of nodes corresponding to a plurality of accounts including: the account; and at least one additional account performing transactions associated with the account during a corresponding time window. An edge between two nodes in the plurality of nodes corresponds to a transaction between two accounts corresponding to the two nodes.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts a system according to embodiments of the present disclosure.

FIG. 5 depicts an example self-attention module according to embodiments of the present disclosure.

FIG. 6 depicts a flowchart of an example method for transaction data processing according to embodiments of the present disclosure.

Throughout the drawings, same or similar reference numerals represent the same or similar elements.

### DETAILED DESCRIPTION

A dynamic graph embedding method for transaction data analysis includes obtaining transaction data associated with an account during a plurality of time windows, extracting spatial-temporal information of the transaction data by using a graph convolutional network and a transformer framework, and generating a feature representation for the account based on the spatial-temporal information.

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

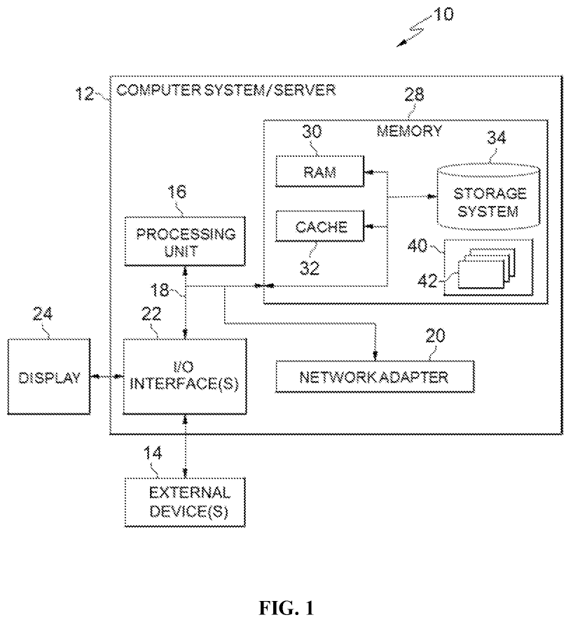

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

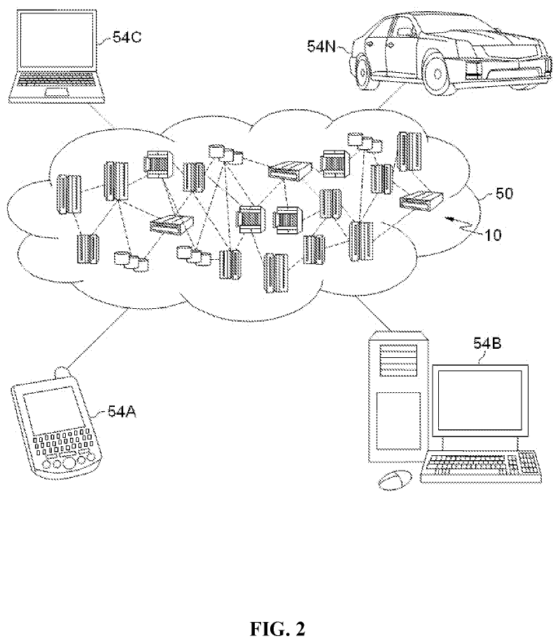

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

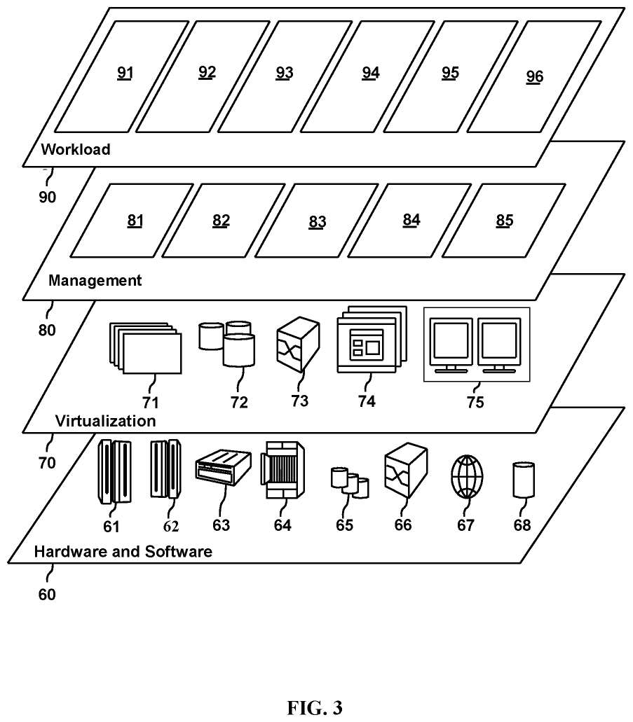

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

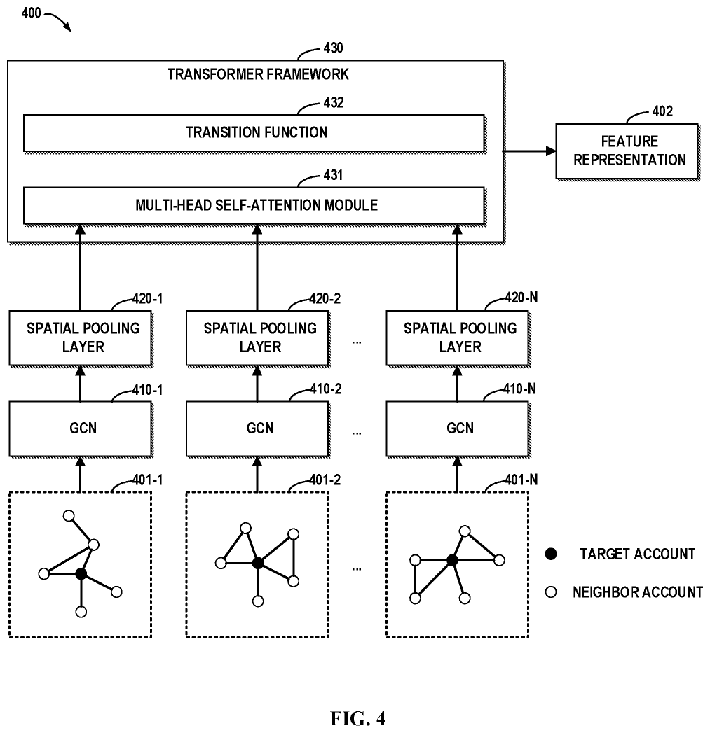

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transaction data processing 96. Hereinafter, reference will be made to FIG. 4-6 to describe details of the transaction data processing 96.

As described above, transaction data is usually represented as a heterogeneous graph of market participants, in which multiple nodes representing multiple accounts are connected by edges representing transactions. This is a particularly useful formulation for tackling critical business problems like credit risk modeling, fraud detection, money laundering detection and the like. However, such a graph is usually very high dimensional (for example, with tens or hundreds of millions of nodes) and very sparse (for example, with each node interacting with a fraction of the other nodes), thus limiting the utility of the graph for financial data analysis tasks.

In recent years, graph embedding techniques have grown in popularity as means for learning latent representations of nodes in a graph. Certain techniques like DeepWalk, Struc2vec, node2vec and the like attempt to encode the topological structure from a graph into dense representations. This is commonly referred to as geometric similarity, which captures both the graphical substructure as well as the similarity among any ancillary features that belong to any particular node. However, these techniques usually do not consider spatial-temporal information of transaction data.

In order to at least partially solve the above and other potential problems, embodiments of the present disclosure provide a solution for transaction data processing. According to the solution, transaction data associated with an account during a plurality of time windows may be obtained. Spatial-temporal information of the transaction data may be extracted by using a graph convolutional network (GCN) and a transformer framework. For example, the spatial information of the transaction data may reflect characteristics of transactions between the account and other accounts in a certain time window. The temporal information of the transaction data may reflect characteristics of the account's transaction behaviors over time. A feature representation may be generated for the account based on the spatial-temporal information. For example, the feature representation may be represented as an embedding vector.

As such, the feature representation of the transaction data can serve a downstream analysis task. For example, it can be used to determine whether the transaction behaviors of the account match an abnormal pattern indicating, for example, anti-money laundering, telecom fraud, non-performing loan or the like.

With reference now to FIG. 4, a system 400 in which embodiments of the present disclosure can be implemented is shown. It is to be understood that the structure and functionality of the system 400 are described only for the purpose of illustration without suggesting any limitations as to the scope of the present disclosure. The embodiments of the present disclosure can be embodied with a different structure and/or functionality. For example, at least part or all of the system 400 may be implemented by computer system/server 12 of FIG. 1.

In some embodiments, the system 400 may obtain transaction data associated with an account. The transaction data may be divided into a plurality of time windows. The time windows may have the same duration or have different durations.

As shown in FIG. 4, the transaction data associated with the account may be represented as a plurality of graphs 401-1, 401-2 . . . 401-N (collectively referred to as “graphs 401” or individually referred to as “graph 401”, where N [symbol] 1) corresponding to a plurality of time windows T₁, T₂ . . . T_{N}. Each graph 401 may comprise a plurality of nodes corresponding to a plurality of accounts including the account (also referred to as “target account” and shown by a solid dot in FIG. 4) and at least one neighbor account (shown by hollow dots in FIG. 4) which performs transactions associated with the account during a corresponding time window. An edge between two nodes in each graph 401 may correspond to a transaction between two accounts corresponding to the two nodes.

In some embodiments, the system 400 may extract spatial-temporal information of the transaction data by using GCNs 410-1, 410-2 . . . 410-N (collectively referred to as “GCNs 410” or individually referred to as “GCN 410”) and a transformer framework 430.

As shown in FIG. 4, for example, the graph 401-1 may be input to the GCN 410-1, where the GCN 410-1 may generate a feature vector for each node in the graph 401-1. A spatial pooling layer 420-1 may aggregate all of feature vectors generated for the graph 401-1 and output a vector representing spatial information of the graph 401-1. For example, the spatial information of the graph 401-1 may reflect characteristics of transaction behaviors of the account during the time window T₁.

Similarly, the graph 401-2 may be input to the GCN 410-2, where the GCN 410-2 may generate a feature vector for each node in the graph 401-2. A spatial pooling layer 420-2 may aggregate all of feature vectors generated for the graph 401-2 and output a vector representing spatial information of the graph 401-2. The graph 401-N may be input to the GCN 410-N, where the GCN 410-N may generate a feature vector for each node in the graph 401-N. A spatial pooling layer 420-N may aggregate all of feature vectors generated for the graph 401-N and output a vector representing spatial information of the graph 401-N.

The vectors representing respective spatial information of the graphs 401 may be input to the transformer framework 430. The transformer framework 430 may extract spatial-temporal information of the transaction data based on the vectors representing respective spatial information of the graphs 401. For example, the spatial-temporal information of the transaction data may reflect characteristics of transaction behaviors of the account over different time windows. The transformer framework 430 may generate a feature representation 402 for the account based on the extracted spatial-temporal information. For example, the feature representation 402 may be represented as an embedding vector.

As shown in FIG. 4, the transformer framework 430 may comprise a multi-head self-attention module 431 and a transition function 432. For example, at time t, the multi-head self-attention module 431 may output a vector A^{t} representing the extracted spatial-temporal information of the transaction data. The output of the transformer framework 430 may be represented as below:

H^{t}=LNorm(A^{t}+Trans(A^{t})), (1)

where LNorm represents a normalization function and Trans represents the transition function 432. In some embodiments, the output of the transformer framework 430 at time t may be used for determining the output of the transformer framework 430 at time t+1 as legacy solutions. In some embodiments, the transformer framework 430 may be trained in an unsupervised manner based on a sampled softmax loss function, so as to maximize the differentiation of feature representations generated by the transformer module 430 for different accounts.

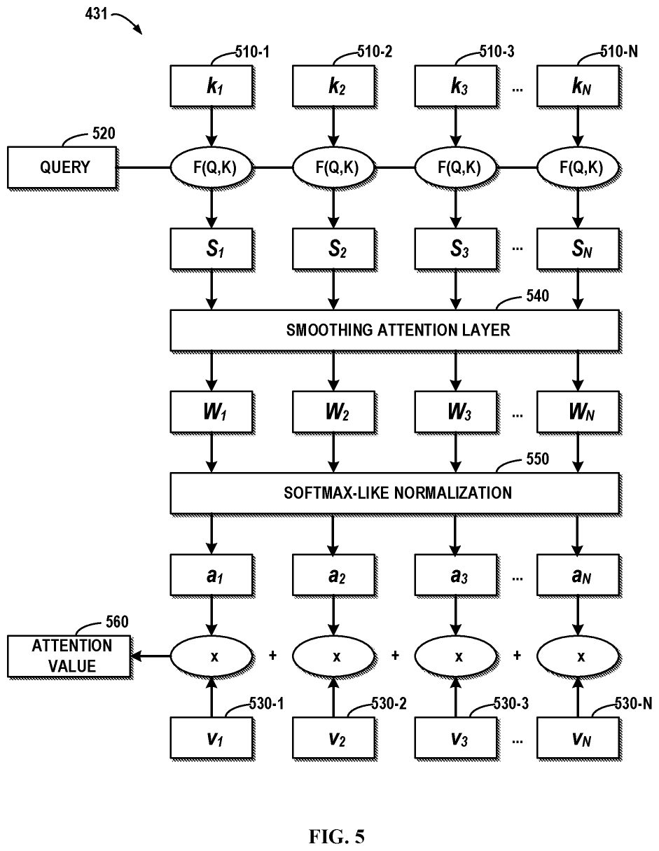

FIG. 5 illustrates an example of the multi-head self-attention module 431 according to embodiments of the present disclosure.

As shown in FIG. 5, respective spatial information of the plurality of graphs 401 may be linearly projected into different spaces, to derive a plurality of key vectors 510-1, 510-2 . . . 510-N (collectively referred to as “key vectors 510” or “keys 510”), a plurality of query vectors q₁, q₂ . . . q_{N} (collectively shown by “query 520” in FIG. 5), a plurality of value vectors 530-1, 530-2 . . . 530-N (collectively referred to as “value vectors 530” or “values 530”). In the following, a key vector 510-i (where 1 [symbol] i [symbol] N) is also represented as “kᵢ” and a value vector 530-i (where 1 [symbol] i [symbol] N) is also represented as “vᵢ”. The multi-head self-attention module 431 may determine an attention distribution over the key vectors 510 based on the query vectors q₁, q₂ . . . q_{N} (that is, the query 520), where the attention distribution indicates respective attention weights S₁, S₂ . . . S_{N} of respective spatial information of the graphs 401.

For example, with respect to the graph 401-j (where 1 [symbol] j [symbol] N), it corresponds to a time window Tⱼ and corresponds to a key vector 510-j (that is, kⱼ). An attention weight Sj of the key vector 510-j may be determined by aggregating attentions scores between the query vectors q₁, q₂ . . . q_{N} (that is, the query 520) and the key vector kⱼ.

In some embodiments, an attention score between the query vector qᵢ and the key vector kⱼ may be determined as below:

A_{i,j}^{abs}=qᵢ^{T}kⱼ (2)

In the above formula (2), the query vector qᵢ may be represented as W_{q}(Eₓᵢ+Uᵢ), where W_{q} represents a query weight transformation matrix, Eₓᵢ represents an embedding of the graph 401-i, Uᵢ represents an absolute position vector of the graph 401-i. The key vector kⱼ may be represented as Wₖ(Eₓⱼ+Uⱼ), where Wₖ represents a key weight transformation matrix, Eₓⱼ represents an embedding of the graph 401-j, Uⱼ represents an absolute position vector of the graph 401-j. Thus, the above formula (2) can be converted to the following formula (3):

A_{i,j}^{abs}=Eₓᵢ^{T}WₖEₓⱼ+Eₓᵢ^{T}W_{q}^{T}WₖUⱼ+Uᵢ^{T}W_{q}^{T}WₖEₓⱼ+Uᵢ^{T}Wᵢ^{T}WₖUⱼ (3)

In some embodiments, by replacing the absolute position vector Uⱼ with a relative position vector Rᵢ₋ⱼ, which is derived by encoding a position of the time window Tᵢ relative to the time window Tⱼ, the above formula (3) can be converted to the following formula (4):

A_{i,j}^{abs}=Eₓᵢ^{T}W_{q}^{T}W_{k,E}Eₓⱼ+Eₓᵢ^{T}W_{q}^{T}W_{k,R}Rᵢ₋ⱼ+u^{T}W_{k,E}Eₓⱼ+v^{T}W_{k,R}Rᵢ₋ⱼ (4)

where u and v are parameter vectors corresponding to the time interval between the time windows Tᵢ and Tⱼ. W_{k,E} and W_{k,R} are key weight transformation matrixes transformed from the key weight transformation matrix Wₖ.

In some embodiments, the time interval between the time windows Tᵢ and Tⱼ may be classified into one of the following categories: long time interval, medium time interval and short time interval. For example, if the time interval between the time windows Tᵢ and Tⱼ exceeds a first threshold (for example, 1 month), the time interval between the time windows Tᵢ and Tⱼ may belong to a long time interval. If the time interval between the time windows Tᵢ and Tⱼ exceeds a second threshold (for example, 1 day) but does not exceed the first threshold, it may belong to a medium time interval. Otherwise, if the time interval between the time windows Tᵢ and Tⱼ does not exceed the second threshold, it may belong to a short time interval. In some embodiments, a long time interval may correspond to parameter vectors uₗ and vₗ, a medium time interval may correspond to parameter vectors uₘ and vₘ and a short time interval may correspond to parameter vectors uₛ and vₛ, where uₗ, uₘ, uₛ, vₗ, vₘ and vₛ can be learned in advance. That is, in the above formula (4), the parameter vectors U and v can be represented as:

$$u = {S ( \begin{matrix}{u}_{l} \\ {u}_{m} \\ {u}_{s}\end{matrix} )}^{T} , v = {S ( \begin{matrix}{v}_{l} \\ {v}_{m} \\ {v}_{s}\end{matrix} )}^{T} \qquad ( 5 )$$

where if the time interval between the time windows Tᵢ and Tⱼ is a long time interval, S=(1, 0, 0); if the time interval between the time windows Tᵢ and Tⱼ is a medium time interval, S=(0, 1, 0); and if the time interval between the time windows Tᵢ and Tⱼ is a short time interval, S=(0, 0, 1).

As such, the attention score between the query vector qᵢ and the key vector kⱼ can be determined. The attention weight Sj associated with the key vector kⱼ may be determined by aggregating attention scores between the query vectors q₁, q₂ . . . q_{N} and the key vector kⱼ.

In some embodiments, as shown in FIG. 5, the multi-head self-attention module 431 may comprise a smoothing attention layer 540 for smoothing the determined attention distribution (that is, the attention weights S₁, S₂ . . . S_{N}) over the key vectors 510. For example, the smoothing attention layer 540 may be implemented by a bi-directional first order filter. The attention weight Sᵢ (where 1 [symbol] i [symbol] N) of the key vector 510-i may be updated to a smoothed attention weight Wᵢ as below:

Wᵢ=(S′(i)+S″(i))/2,

where S′(i)=αSᵢ+(1−α)Sᵢ₋₁ and S″(i)=βSᵢ+(1−β)Sᵢ₊₁ (6)

In the above formula (6), α and β are predetermined parameters, which can vary with i.

In some embodiments, as shown in FIG. 5, the multi-head self-attention module 431 may comprise a softmax-like normalization layer 550 for normalizing the smoothed attention weights W₁, W₂ . . . W_{N}, to derive the final attention weights a₁, a₂ . . . a_{N} of the key vectors 510. The multi-head self-attention module 431 may aggregate the value vectors 530 based on the attention weights a₁, a₂ . . . a_{N}, to derive an attention value vector 560 (that is, A^{t}). The attention value vector 560 may reflect the spatial-temporal information of the transaction data associated with the account.

With reference back to FIG. 4, the output of the multi-head self-attention module 431 may be provided to the transition function 432. The transformer framework 430 may output a feature representation 402 according to the formula (1) as described above.

The feature representation 402 can serve a downstream analysis task. In some embodiments, the feature representation 402 can be used to determine whether transaction behaviors of the account during the plurality of time windows are abnormal or not. For example, it can be determined that whether the feature representation 402 matches an abnormal pattern indicating, for example, anti-money laundering, telecom fraud, non-performing loan or the like. As such, the feature representation 402 can be used to tackle critical business problems in financial analysis tasks.

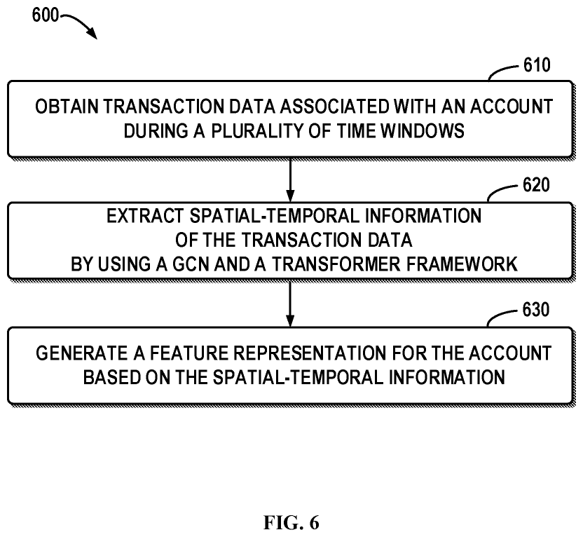

FIG. 6 depicts a flowchart of an example method 600 for transaction data processing according to embodiments of the present disclosure. The method 600 may be implemented by the system 400 as shown in FIG. 4. It is to be understood that the method 900 may also comprise additional blocks (not shown) and/or may omit the illustrated blocks. The scope of the present disclosure described herein is not limited in this aspect.

At block 610, the system 400 obtains transaction data associated with an account during a plurality of time windows.

In some embodiments, the transaction data may be represented as a plurality of graphs (for example, the graphs 401 as shown in FIG. 4) corresponding to the plurality of time windows. Each graph may comprise a plurality of nodes corresponding to a plurality of accounts including the account and at least one account which performs transactions associated with the account during a corresponding time window. An edge between two nodes in the plurality of nodes may correspond to a transaction between two accounts corresponding to the two nodes.

At block 620, the system 400 extracts spatial-temporal information of the transaction data by using a graph convolutional network (for example, the GCN 410 as shown in FIG. 4) and a transformer framework (for example, the transformer framework 430 as shown in FIG. 4).

In some embodiments, in order to extract the spatial-temporal information of the transaction data, the system 400 may generate, for each graph in the plurality of graphs, respective feature vectors of a plurality of nodes in the graph by using the graph convolutional network and determine spatial information of the graph by aggregating the feature vectors. The system 400 may extract the spatial-temporal information of the transaction data based on respective spatial information of the plurality of graphs by using the transformer framework.

In some embodiments, in order to extract the spatial-temporal information of the transaction data based on respective spatial information of the plurality of graphs, the system 400 may generate a plurality of query vectors (for example, the query 520 as shown in FIG. 5), a plurality of key vectors (for example, the key vectors 510 as shown in FIG. 5) and a plurality of value vectors (for example, the value vectors 530 as shown in FIG. 5) corresponding to the plurality of graphs by projecting the respective spatial information of the plurality of graphs into different spaces. The system 400 may determine respective attention weights (for example, the attention weights S₁, S₂ . . . S_{N} as shown in FIG. 5) of the plurality of graphs based on the plurality of query vectors and the plurality of key vectors and determine the spatial-temporal information of the transaction data by aggregating the plurality of value vectors based on the attention weights.

In some embodiments, a first graph in the plurality of graphs may correspond to a first time window in the plurality of time windows. The plurality of key vectors may comprise a first key vector corresponding to the first graph. In order to determine respective attention weights of the plurality of graphs, the system 400 may determine time intervals between the plurality of time windows and the first time window; generate relative position vectors by encoding positions of the plurality of time windows relative to the first time window; determine a plurality of attention scores between the plurality of query vectors and the first key vector based on the relative position vectors and parameter vectors corresponding to the time intervals; and determine an attention weight of the first graph based on the plurality of attention scores.

In some embodiments, in order to aggregate the plurality of value vectors based on the attention weights, the system 400 may smooth the attention weights by using a smoothing attention layer (for example, the smoothing attention layer 540 as shown in FIG. 5) in the transformer framework and aggregate the plurality of value vectors based on the smoothed attention weights.

At block 630, the system 400 generates a feature representation (for example, the feature representation 402 as shown in FIG. 4) for the account based on the spatial-temporal information.

In some embodiments, the system 400 may further determine whether transaction behaviors of the account during the plurality of time windows are abnormal based on the feature representation.

It can be seen that embodiments of the present disclosure provide a solution for transaction data processing. This solution utilizes GCNs and a transformer framework to extract spatial information of transaction data associated with an account and generates a feature representation for the account based on the spatial-temporal information. As such, the feature representation of the transaction data can serve a downstream analysis task. For example, it can be used to determine whether the transaction behaviors of the account match an abnormal pattern indicating, for example, anti-money laundering, telecom fraud, non-performing loan or the like.

Embodiments of the present disclosure relate to a solution for transaction data processing. According to the solution, transaction data associated with an account during a plurality of time windows may be obtained. Spatial-temporal information of the transaction data may be extracted by using a graph convolutional network and a transformer framework. A feature representation may be generated for the account based on the spatial-temporal information. In some embodiments, a corresponding method, system, and computer program product are provided.

It should be noted that the processing of transaction data according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
obtaining transaction data associated with an account during a plurality of time windows;
extracting spatial-temporal information of the transaction data by using a graph convolutional network and a transformer framework; and
generating a feature representation for the account based on the spatial-temporal information.

2. The computer-implemented method of claim 1, wherein:
the transaction data is represented as a plurality of graphs corresponding to the plurality of time windows,
each graph comprises a plurality of nodes corresponding to a plurality of accounts including:
the account; and
at least one additional account performing transactions associated with the account during a corresponding time window, and
an edge between two nodes in the plurality of nodes corresponds to a transaction between two accounts corresponding to the two nodes.

3. The computer-implemented method of claim 2, wherein extracting the spatial-temporal information of the transaction data includes:
for each graph in the plurality of graphs:
generating respective feature vectors of a plurality of nodes in the graph by using the graph convolutional network;
determining spatial information of the graph by aggregating the feature vectors; and
extracting the spatial-temporal information of the transaction data based on respective spatial information of the plurality of graphs by using the transformer framework.

4. The computer-implemented method of claim 3, wherein extracting the spatial-temporal information of the transaction data based on respective spatial information of the plurality of graphs includes:
generating a plurality of query vectors, a plurality of key vectors and a plurality of value vectors corresponding to the plurality of graphs by projecting the respective spatial information of the plurality of graphs into different spaces;
determining respective attention weights of the plurality of graphs based on the plurality of query vectors and the plurality of key vectors; and
determining the spatial-temporal information of the transaction data by aggregating the plurality of value vectors based on the attention weights.

5. The computer-implemented method of claim 4, wherein aggregating the plurality of value vectors based on the attention weights includes:
smoothing the attention weights by using a smoothing attention layer in the transformer framework; and
aggregating the plurality of value vectors based on the smoothed attention weights.

6. The computer-implemented method of claim 5, wherein:
a first graph in the plurality of graphs corresponds to a first time window in the plurality of time windows, the plurality of key vectors includes a first key vector corresponding to the first graph, and
determining respective attention weights of the plurality of graphs includes:
determining time intervals between the plurality of time windows and the first time window;
generating relative position vectors by encoding positions of the plurality of time windows relative to the first time window;
determining a plurality of attention scores between the plurality of query vectors and the first key vector based on the relative position vectors and parameter vectors corresponding to the time intervals; and
determining an attention weight of the first graph based on the plurality of attention scores.

7. The computer-implemented method of claim 1, further comprising:
determining whether transaction behaviors of the account during the plurality of time windows are abnormal based on the feature representation.

8. A computer system comprising:
a processing unit; and
a memory coupled to the processing unit and storing instructions thereon, the instructions, when executed by the processing unit, performing actions comprising:
obtaining transaction data associated with an account during a plurality of time windows;
extracting spatial-temporal information of the transaction data by using a graph convolutional network and a transformer framework; and
generating a feature representation for the account based on the spatial-temporal information.

9. The computer system of claim 8, wherein:
the transaction data is represented as a plurality of graphs corresponding to the plurality of time windows,
each graph comprises a plurality of nodes corresponding to a plurality of accounts including:
the account, and
at least one additional account performing transactions associated with the account during a corresponding time window, and
an edge between two nodes in the plurality of nodes corresponds to a transaction between two accounts corresponding to the two nodes.

10. The computer system of claim 9, wherein extracting the spatial-temporal information of the transaction data comprises:
for each graph in the plurality of graphs:
generating respective feature vectors of a plurality of nodes in the graph by using the graph convolutional network;
determining spatial information of the graph by aggregating the feature vectors; and
extracting the spatial-temporal information of the transaction data based on respective spatial information of the plurality of graphs by using the transformer framework.

11. The computer system of claim 10, wherein extracting the spatial-temporal information of the transaction data based on respective spatial information of the plurality of graphs includes:
generating a plurality of query vectors, a plurality of key vectors and a plurality of value vectors corresponding to the plurality of graphs by projecting the respective spatial information of the plurality of graphs into different spaces;
determining respective attention weights of the plurality of graphs based on the plurality of query vectors and the plurality of key vectors; and
determining the spatial-temporal information of the transaction data by aggregating the plurality of value vectors based on the attention weights.

12. The computer system of claim 11, wherein aggregating the plurality of value vectors based on the attention weights includes:
smoothing the attention weights by using a smoothing attention layer in the transformer framework; and
aggregating the plurality of value vectors based on the smoothed attention weights.

13. The computer system of claim 12, wherein:
a first graph in the plurality of graphs corresponds to a first time window in the plurality of time windows, the plurality of key vectors includes a first key vector corresponding to the first graph, and
determining respective attention weights of the plurality of graphs includes:
determining time intervals between the plurality of time windows and the first time window;
generating relative position vectors by encoding positions of the plurality of time windows relative to the first time window;
determining a plurality of attention scores between the plurality of query vectors and the first key vector based on the relative position vectors and parameter vectors corresponding to the time intervals; and
determining an attention weight of the first graph based on the plurality of attention scores.

14. The computer system of claim 8, wherein the actions further comprise:
determining, based on the feature representation, whether transaction behaviors of the account during the plurality of time windows are abnormal.

15. A computer program product comprising a computer-readable storage medium having a set of instructions stored therein which, when executed by a processor, causes the processor to perform a method comprising:
obtaining transaction data associated with an account during a plurality of time windows;
extracting spatial-temporal information of the transaction data by using a graph convolutional network and a transformer framework; and
generating a feature representation for the account based on the spatial-temporal information.

16. The computer program product of claim 15, wherein:
the transaction data is represented as a plurality of graphs corresponding to the plurality of time windows,
each graph comprises a plurality of nodes corresponding to a plurality of accounts including:
the account, and
at least one additional account performing transactions associated with the account during a corresponding time window, and
an edge between two nodes in the plurality of nodes corresponds to a transaction between two accounts corresponding to the two nodes.

17. The computer program product of claim 16, wherein extracting the spatial-temporal information of the transaction data includes:
for each graph in the plurality of graphs,
generating respective feature vectors of a plurality of nodes in the graph by using the graph convolutional network;
determining spatial information of the graph by aggregating the feature vectors; and
extracting the spatial-temporal information of the transaction data based on respective spatial information of the plurality of graphs by using the transformer framework.

18. The computer program product of claim 17, wherein extracting the spatial-temporal information of the transaction data based on respective spatial information of the plurality of graphs by using the transformer framework includes:
generating a plurality of query vectors, a plurality of key vectors and a plurality of value vectors corresponding to the plurality of graphs by projecting the respective spatial information of the plurality of graphs into different spaces;
determining respective attention weights of the plurality of graphs based on the plurality of query vectors and the plurality of key vectors; and
determining the spatial-temporal information of the transaction data by aggregating the plurality of value vectors based on the attention weights.

19. The computer program product of claim 18, wherein aggregating the plurality of value vectors based on the attention weights includes:
smoothing the attention weights by using a smoothing attention layer in the transformer framework; and
aggregating the plurality of value vectors based on the smoothed attention weights.

20. The computer program product of claim 15, wherein the actions further comprise:
determining, based on the feature representation, whether transaction behaviors of the account during the plurality of time windows are abnormal.
